(19) United States
(12) Patent Application Publication
(10) Pub. No.: US 2006/0144868 A1
(43) Pub. Date: Jul. 6, 2006

(54) Polymeric container and method of manufacturing the container

(75) Inventors: Michael B. Brisbois, Centennial, CO (US); Kenneth W. House, Fort Collins, CO (US); Douglas P. Collins, Loveland, CO (US)

Correspondence Address: LEYENDECKER LEMIRE & DALEY, LLC, C/O PORTFOLIO IP, P.O. BOX 52050, MINNEAPOLIS, MN, 55402, US

(73) Assignee: Michael Brisbois

(21) Appl. No.: 11/394,002

(22) Filed: Mar. 30, 2006

(51) Int. Cl. B67D 5/40; B67D 5/60

(52) U.S. Cl. 222/377; 222/464.7

(57) ABSTRACT

Embodiments of the present invention include a polymeric container that can rest upright on a horizontal surface but includes a sloped interior bottom surface that causes any liquid contained therein to flow to a particular location in the container wherein substantially all the liquid be withdrawn from the container using a pump dispenser. Other embodiments describe the manufacture of the container.

### FIELD OF THE INVENTION

This invention relates generally to polymeric containers.

### BACKGROUND

Numerous liquid products are provided to consumers in containers with convenient pump/spray dispensers attached to the container's mouth. These pump dispensers usually include a straw or siphon tube that extends downwardly towards the bottom of the container wherein the liquid is sucked upwardly from an open end of the tube.

Because the typical container utilized with pump dispensers has a flat bottom to facilitate stable placement on a horizontal surface and because the tube end intake requires a certain depth of liquid to facilitate pumping, the pump dispenser invariably stops functioning before all the liquid material is removed from the container. The problem is generally more pronounced with more viscous liquid materials but does also occur to some extent in less viscous materials.

In order to utilize, the remaining liquid, a user must often remove the dispenser and pour the contents out of the bottle. However, rather than hassle with removing the liquid and possibly creating a mess, the user often disposes of the container with its residual liquid contents left unused.

Numerous container designs to solve the aforementioned problem have been proposed, such as described in U.S. patent application 20010030203 and U.S. Pat. Nos. 5,062,549 and 6,834,815. However, while most of these containers are successful in solving the liquid removal problem, the containers themselves are typically much more difficult and costly to manufacture. Often the value of liquid material lost because of difficulty removing it from a flat bottom container design is less than the cost to manufacture the proposed containers.

### BRIEF DESCRIPTION OF THE DRAWINGS

FIG. 1 is an isometric view of a first embodiment container with a pump type dispenser attached thereto including a cutaway illustrating the dispenser's siphon tube.

FIG. 2a is cutaway partial isometric view of the first embodiment container illustrating its bottom end from a first perspective.

FIG. 2b is cutaway partial isometric view of the first embodiment container illustrating its bottom end from a second perspective.

FIG. 3a is cutaway partial isometric view of the second embodiment container illustrating its bottom end.

FIG. 3b is cutaway partial isometric view of the second embodiment container illustrating its bottom end from a second perspective.

FIG. 3c is cutaway partial isometric view of the second embodiment container illustrating its bottom end from a third perspective.

FIG. 4a is cutaway partial isometric view of the second embodiment container prior to compression/compaction of the feet illustrating its bottom end from the same perspective as FIG. 3b.

FIG. 4b is cutaway partial isometric view of the second embodiment container prior to compression/compaction of the feet illustrating its bottom end from the same perspective as FIG. 3c.

FIG. 5a is cutaway partial isometric view of the third embodiment container illustrating its bottom end from a first perspective.

FIG. 5b is cutaway partial isometric view of the third embodiment container illustrating its bottom end from a second perspective.

FIG. 6 is cutaway partial isometric view of the third embodiment container prior to compression of the feet illustrating its bottom end from the same perspective as FIG. 5a.

FIG. 7a is a cross sectional view of the second embodiment container as taken along line 7-7 of FIG. 3c including the blow molding die in its position prior to the compression of the legs.

FIG. 7b is a cross sectional view of the second embodiment container as taken along line 7-7 of FIG. 3c including the blow molding die during the compression of the legs.

FIG. 8a is a cross sectional view of the third embodiment container as taken along line 8-8 of FIG. 5b including the blow molding die in its position prior to the compression of the legs.

FIG. 8b is a cross sectional view of the third embodiment container as taken along line 8-8 of FIG. 5b including the blow molding die during the compression of the legs.

FIG. 9a is cutaway partial isometric side view of the fourth embodiment container illustrating a flexible thin substrate label wrapped fully around the circumference of the container.

FIG. 9b is a cutaway partial isometric top view of the fourth embodiment container illustrating a pair of flexible thin substrate labels applied to the flat sides of the container.

FIG. 9c is a cutaway partial isometric top view of the fourth embodiment container.

FIG. 10a is cutaway partial isometric side view of the fifth embodiment container illustrating a flexible thin substrate label wrapped fully around the circumference of the container.

FIG. 10b is a cutaway partial isometric top view of the fifth embodiment container illustrating a pair of flexible thin substrate labels applied to the flat sides of the container.

FIG. 10c is a cutaway partial isometric top view of the fifth embodiment container.

### DETAILED DESCRIPTION

Embodiments of the present invention include containers for use with pump/spray dispensers that utilize siphon tubes. The containers are typically comprised of polymeric materials that lend themselves to rapid manufacturing techniques such as blow molding. The containers include bottoms that are configured to direct any liquid contained therein to low spot or reservoir region of the bottom on its interior surface whereat the siphon tube terminates. Advantageously, less residual liquid is left in the container once the pump dispenser ceases to function when the intake end of the siphon tube is at least partially uncovered and exposed to air. Some embodiments of the container can be used to dispense liquid from a stationary position on a flat, level surface, such as a countertop. Products, such as hand lotion, sunscreen, mustard, etc., would be more completely consumed using these container embodiments. Dispensing of liquids is further improved in other container embodiments intended for hand-held use, such as with a squeeze trigger for dispensing liquid household cleaning agents.

Further, container embodiments of the present invention each include one or more feet that are integrally and unitarily fabricated with the container that support the container in a substantially upright orientation when the container is in use and/or is being stored. Also advantageously, the amount of polymeric material required to form the legs is relatively small compared to some prior art containers that include solid sections of relatively large volumes.

At least one embodiment of the present invention also includes a method of manufacturing containers having one or more of the advantages recited in the proceeding paragraphs. First, the container is blown using a blow molding apparatus in a conventional manner in the shape of an interior of a provided die/tool. Next, one or more specifically located sliders that are part of the die/tool are activated to compact the as-blown sides of one or more legs together while the polymeric material is still in a molten or a semi-molten state. Because the leg compaction operation is performed while the container is cooling to a suitable temperature for removal from the associated die, this operation adds little or no time to the container manufacturing process. Because the thickness of the compacted legs is only about two times the typical wall thickness of the blow molded container, the amount of additional material required to manufacture the container is relatively small.

Other embodiments provide a tack-off feature that permits the liquid in such a container to gather at a low point proximate a siphon but at the same time provides a flat bottom portion to hold the container in a stable upright position. In some variations incorporating the tack-off feature, one or more flexible labels are utilized as tension members to stabilize and strengthen the container at the location of the tack-off feature. Given the general configuration of the tack-off feature embodiments, additional space is provided on the exterior of the container for one or more labels increasing the amount of information and printed marketing material the manufacturer can provide to a consumer thereon.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variation” and similar phrases mean that a particular feature, structure, or characteristic described in connection with the embodiment or variation is included in at least an embodiment or variation of the invention. The phrase “in one embodiment”, “in one variation” or similar phrases as used in various places in the specification are not necessarily meant to refer to the same embodiment or the same variation.

The term “couple” or “coupled” as used in this specification and the appended claims refers to either an indirect or direct connection between the identified elements, components or objects. Often the manner of the coupling will be related specifically to the manner in which the two coupled elements interact.

The phrase “pump dispenser” and its equivalents as used herein refer to any fluid dispenser that utilizes a siphon tube to pull liquid from an end of the tube, through the tube and out of an outlet. The outlet can, but does not necessarily, comprise a spray nozzle or in the case of more viscous liquids a simple outlet opening can be provided. Typically the pump has an up-down operating cycle, but can alternatively utilize finger operated trigger that is cycled back and forth to facilitate the pumping action. As used herein the phrase “spray dispenser” is to be considered synonymous with the phrase “pump dispenser”.

The phrases and word “siphon tube”, “draw tube” and “straw” are used interchangeably herein and are considered synonymous with each other.

The terms “leg”, “feet” and their plurals refer to any appendage that extends downwardly relative to a bottom wall or floor of an associated container. Depending on the embodiment, “legs” may have hollow interiors that can hold liquid or they may be compacted such that they do not define an interior volume.

The terms “molten” and “semi-molten” refer to a state of a polymeric material wherein it will bond or fuse with itself when distinct surfaces of the material are brought into intimate contact and compacted against each other. The material is also considered “semi-molten” if only a portion of the material comprising a container is capable of bonding or fusing with other portions of the container.

Unless otherwise indicated or clearly not applicable because of the context in which the terms or phrases are used: (i) the term “substantially” shall mean, depending on context, either +−10% or equal to or greater than 90%; (ii) the term “generally” shall mean+−25% or equal to or greater than 70%; (iii) the phrase “substantial majority” shall mean at least a 75% majority.

The terms “blank”, “perform” and “parison” are used interchangeably herein.

For purposes of this disclosure, elements in the associated figures are each labeled with a three digit numerical identifier. Where the last two digits of identifiers are similar, the two identifiers reference similar, although not necessary identical, elements or features in the figures. For example the legs are identified as “115” for the first embodiment and the legs in the third embodiment are identified as “315”.

### A First Embodiment Container

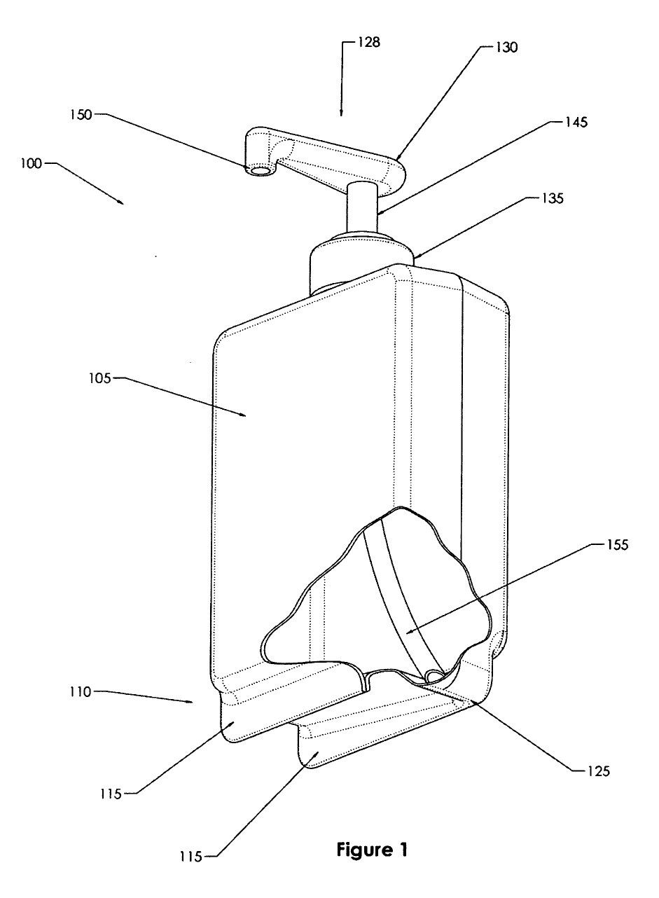

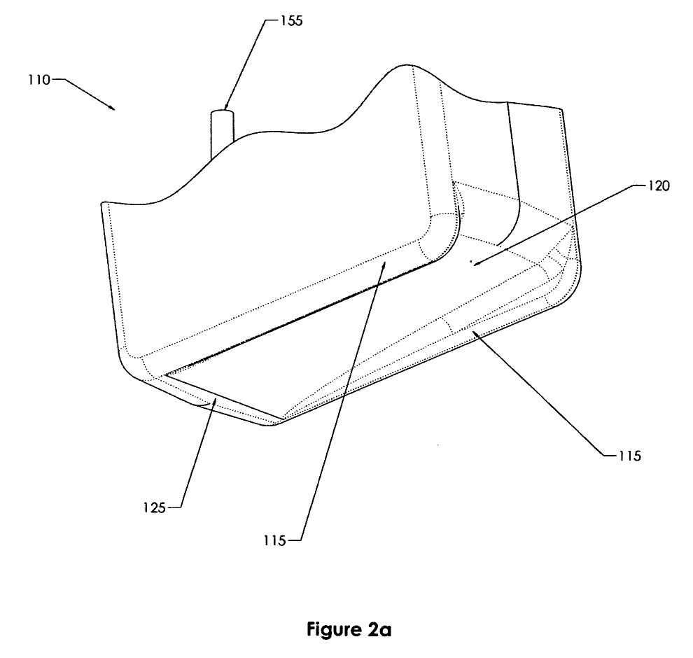

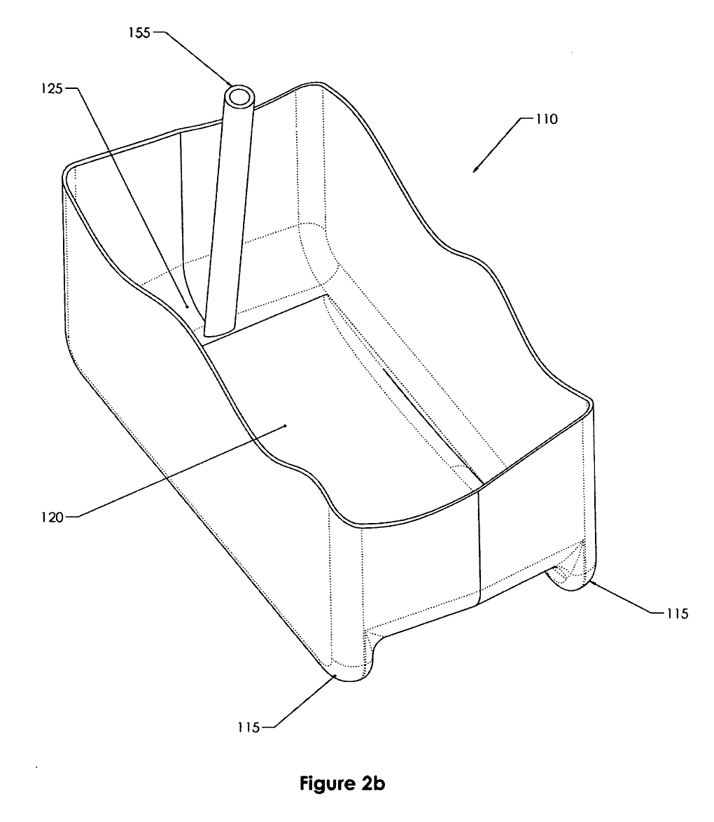

A first embodiment container 100 is illustrated in FIGS. 1-2b FIG. 1 further illustrates a typical vertical pump dispenser 128 as is often used for higher viscosity liquids that may be held within the container. The container comprises one or more thin side walls 105 that along with a bottom end 110 including a thin bottom wall 120 (see FIG. 2a) form an enclosure adapted for containing a suitable liquid material. One or more openings (not labeled) are provided through which the liquid contents can be dispensed from the container. As illustrated, a single opening is located on a top end of the container. The opening will typically include external threads over which an internally threaded adapter 135 of the dispenser 128 is received.

Typically, the container is fabricated from a polymeric material, such as but not limited to polyethylene, polyethylene terephthalate or polypropylene. There are several types of blow molding processes that can be utilized to make the containers of the embodiments described herein as would be understood by one of ordinary skill in the art. However, in the case of injection blow molding, the process involves placing a blank/preform of molten or semi-molten plastic into a hollow interior of a mold and blowing pressurized gas into the blank causing it to inflate. Inflation results in thinning of the preform walls. This inflation and thinning continues until the plastic makes intimate contact with, and conforms to the shape of the interior surfaces of the mold. Contact with the interior mold surfaces cools the plastic and causes it to solidify. The mold is separated and the finished container is removed. In the case of conventional blow molding, a parison takes the place of the preform and some other changes are made to accommodate the difference in the process, as would commonly be known to those skilled in the art.

A typical pump dispenser for higher viscosity liquids comprises a vertically disposed pump body (usually substantially contained within the upper portion of the container and accordingly not shown) containing a pump mechanism therein. The threaded adapter 135 is typically coupled, often pivotally, to the top end of the pump body to facilitate attachment to the opening of an associated container. Typically, a hollow pump shaft 145 extends upwardly from the body and terminates at a nozzle body 130. The nozzle body often includes a flat or slightly depressed upper surface, which when pressed downwardly by the finger of a user actuates the pump mechanism and causes liquid to flow from nozzle outlet 150. From the pumping mechanism a straw/siphon tube 155 extends downwardly into the interior of the associated container terminating proximate or at the bottom of the container 100. It is through the siphon tube that liquid material is pumped into the pump mechanism and eventually out the dispenser's nozzle outlet. The actual configuration of the pump dispenser can vary substantially and significantly from what is illustrated here as would be obvious or known to one of ordinary skill in the art. For example, the pump could comprise a trigger operated spray pump for use with less viscous liquids such as cleaning solutions.

It is to be appreciated that the shape and configuration of the container of the first embodiment can vary substantially depending on its size and the type of liquid material it is designed to contain. Further, the bottles of the second and third embodiments are typically similar to containers of the first embodiment except for differences related to each embodiment's bottom portion 110, 210 and 310.

Referring to FIGS. 2a and 2b, the bottom portion 110 of the first embodiment container is illustrated. The generally rectangular bottom portion includes legs 115 & 125 situated along the bottom wall of the container. The two longitudinal legs 115 extend substantially along the entire length of the container's longitudinal side walls although in variations and other embodiments this need not be the case. The third leg 125 extends widthwise along one lateral side of the container and intersects with the longitudinal legs at its respective ends. Extending widthwise between (i) the longitudinal legs lengthwise and (ii) the third leg and the lateral side wall opposing the third leg widthwise is a sloped bottom wall 120. The bottom wall slopes downwardly towards the third leg.

Referring primarily to FIG. 2b, which illustrates the interior of the bottom portion, the longitudinal legs 115 form a trough having their bottoms below that of the adjacent sloped bottom wall 120. The depth of the trough for each leg decreases as one moves towards the third leg 125 because of the bottom wall's downwardly slope wherein the trough's merge with a widthwise trough or reservoir formed by the third leg. Typically, the siphon tube 155 of the dispenser 128 extends into the third leg reservoir with its intake opening preferably being located at the lowest point in the reservoir. The end of the siphon tube may be cut at an acute angle relative to the axis of the tube to minimize the possibility of the end of the tube creating a seal with the bottom of the container during use.

The container is preferably produced from a suitable polymeric material using blow molding manufacturing techniques well known to those of ordinary skill in the art. Accordingly, the process required to produce the first embodiment bottle is cost competitive with other prior art containers for which the first embodiment container can be substituted.

As any liquid in the first embodiment container is drawn down, the remaining liquid gathers by the force of gravity in the bottoms of the troughs formed by the three legs as opposed to across the entire bottom interior surface, as would be the case with a prior art flat bottom container. The total surface area of the trough bottoms is a mere fraction of the total bottom area of the container that includes the surface area of the bottom wall 120 as well. Assuming that a certain depth of liquid is required for the pump dispenser to operate properly, the total volume of liquid required for the first embodiment to operate properly is much less than the total volume of liquid required in a flat bottomed prior art container, accordingly reducing the volume of liquid waste. It is further appreciated that by tipping container so that the longitudinal legs are raised upwardly relative to the third leg, any liquid remaining in the longitudinal legs will flow into the third leg reservoir permitting its easy and efficient removal.

### A Second Embodiment Container

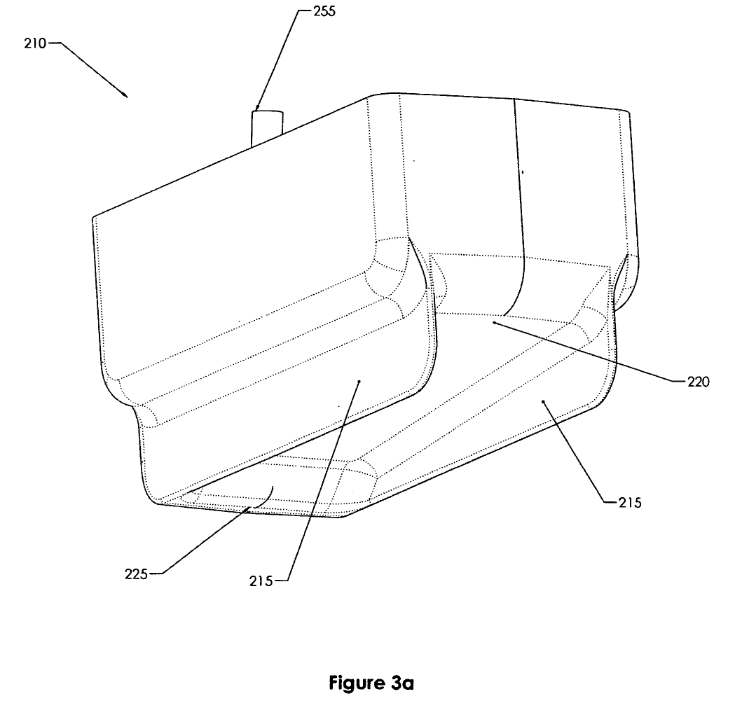

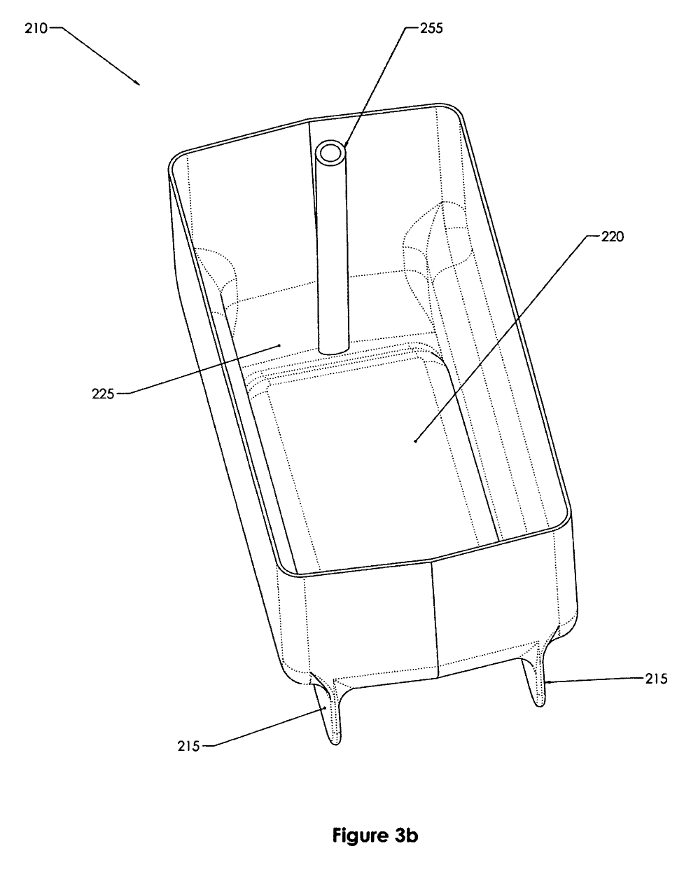

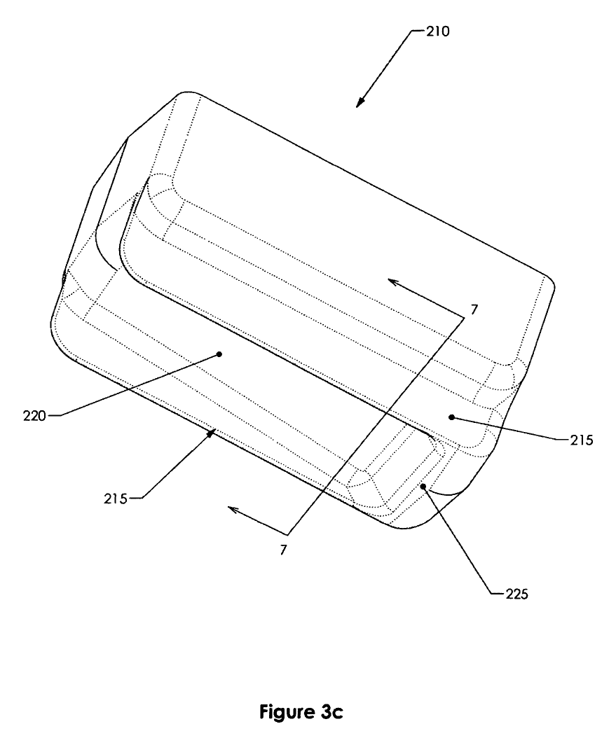

A bottom portion 210 of a second embodiment container is illustrated in FIGS. 3a-3c. The second embodiment container includes several similarities with the first embodiment: both have opposed longitudinal legs 215 & 115; both have widthwise extending third legs 225 & 125 that are located at the intersection with the longitudinal legs proximate one end thereof; and both included a sloped bottom wall 220 & 120 that extends downwardly towards the trough or reservoir formed by the interior surfaces of the third leg.

The second embodiment differs from the first embodiment primarily in that the sidewalls of the longitudinal legs 215 have been compacted together thereby eliminating the interior trough of the first embodiment. Accordingly, the remaining liquid in the container flows to and gathers only in the third leg reservoir wherein the siphon tube 255 is received. Accordingly, only a small volume of liquid is required for the pump dispenser to be operational.

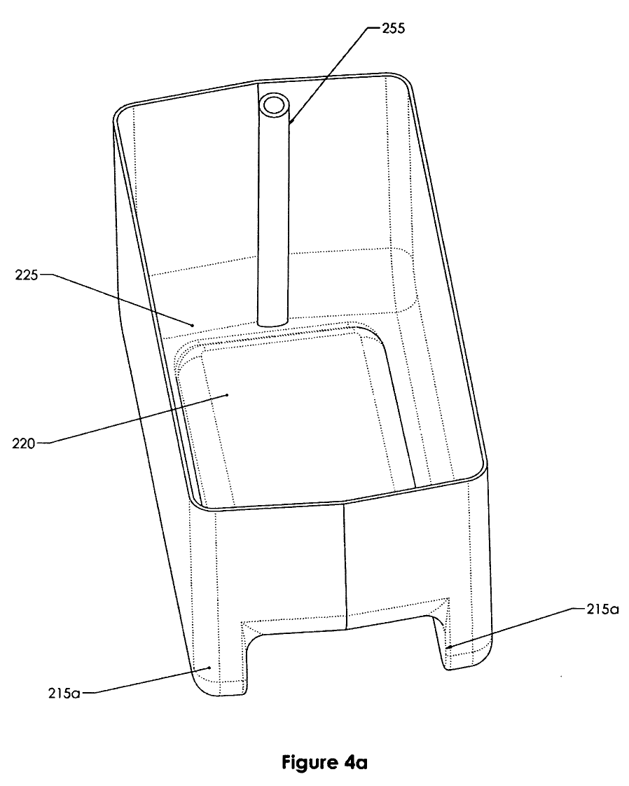

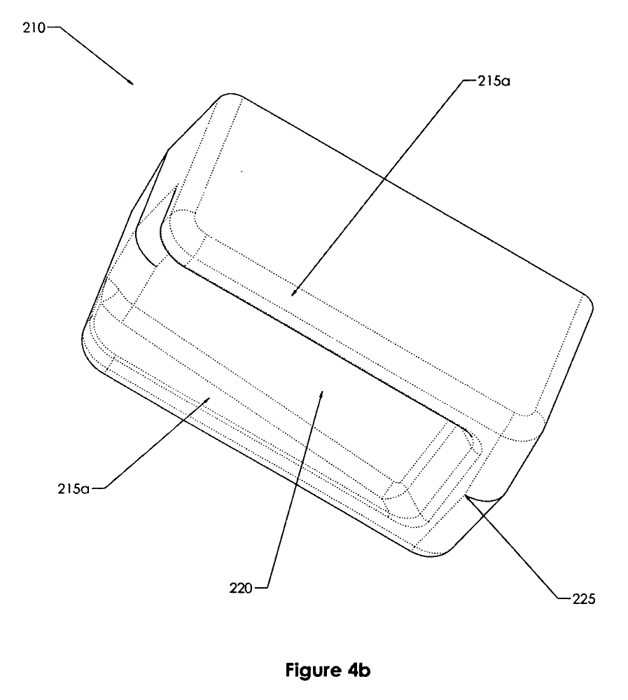

FIGS. 4a&b illustrate the second embodiment container bottom portion 210 prior to compaction of the longitudinal legs 215 and, as shown, it is substantially similar to the first embodiment container save for some minor differences in the longitudinal legs: the legs on the first embodiment are more radiused along their bottom surfaces wherein the longitudinal legs of the second embodiment are flatter and more squared off. During manufacture, the second embodiment container exists for only a very short time in this state as the longitudinal legs are almost immediately compacted.

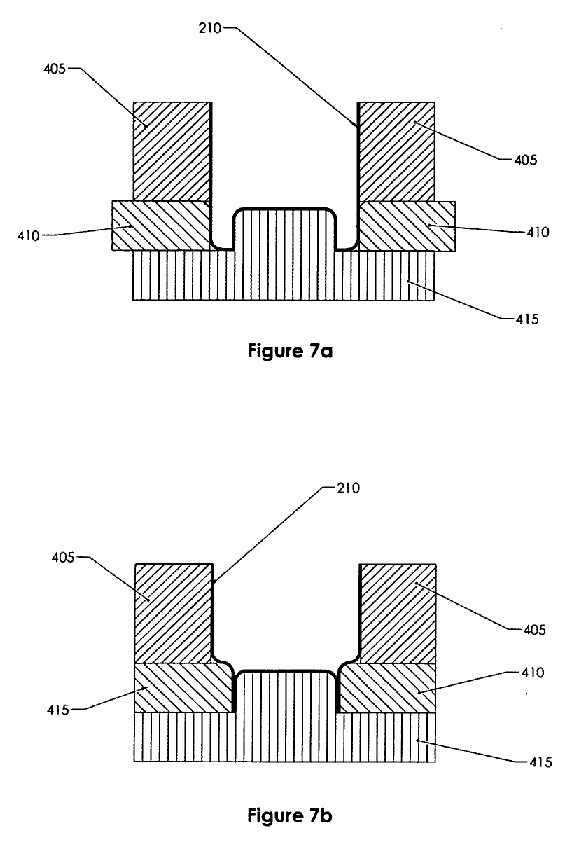

FIG. 7a is a cross-sectional illustration of the second embodiment container's bottom portion 215 while retained in the associated multi-piece blow molding tool (or form) immediately after the molten plastic blank or perform has been blown into shape against the interior sides of the various mold pieces 405,410 & 415. As shown, the interior walls of the left and right side pieces 405 are linearly aligned with the interior walls of the left and right slide pieces 410. The bottom piece 415, which includes a protrusion adapted to form the sloped bottom wall 220 extending upwardly in the widthwise center of the mold.

Once the polymeric material of the blank has been blown against the interior walls of the mold, the lower temperature of the mold walls begin to chill the molten plastic causing it to begin to solidify and depending on the material, crystallize. However, before the polymeric material solidifies, the slide pieces 410 are pressed inwardly into the mold causing the left and right walls of the longitudinal walls (as shown in FIG. 7a) to be compacted and fuse against each other (as shown in FIG. 7b). Typically, the resulting thickness of the compacted and fused leg sidewall is generally twice that of the pre-compacted sidewalls, although depending on how the polymeric material stretched and flowed during the blow molding operation, the thickness of the leg sidewalls before and after compacting can vary substantially relative to the other walls of the container. The sliders can be operated by any suitable means including but not limited to pneumatic, hydraulic and/or mechanical actuators. After solidification, the mold pieces are separated using means and processes well known in the art and the container is removed.

Because the compaction of the legs occurs immediately following the blown expansion of the blank into the mold most often during the period in which the polymeric material is just beginning to cool and solidify, the additional time required to complete the compaction operation is not substantial when compared to the cycle time required to blow mold a prior art container. Further, the amount of additional polymeric material required to fabricate the second embodiment container is small comprising primarily the extra material required for the three legs 215 & 225. Accordingly, the cost to produce the improved second embodiment container is generally, but not necessarily, competitive with flat bottomed prior art containers.

### A Third Embodiment Container

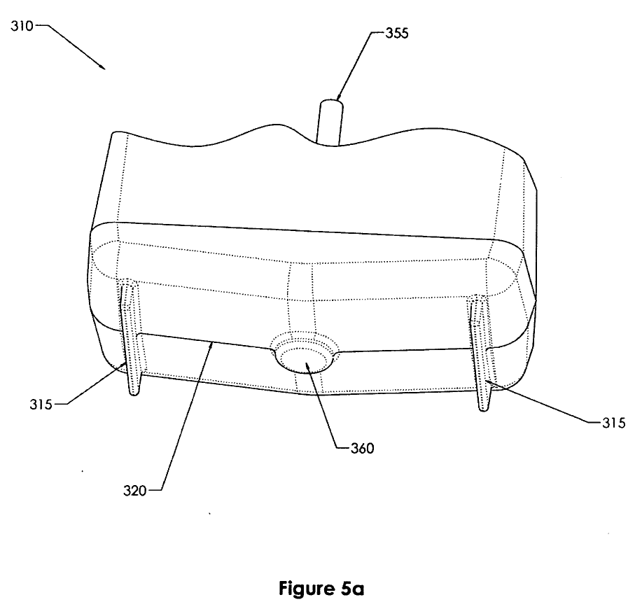

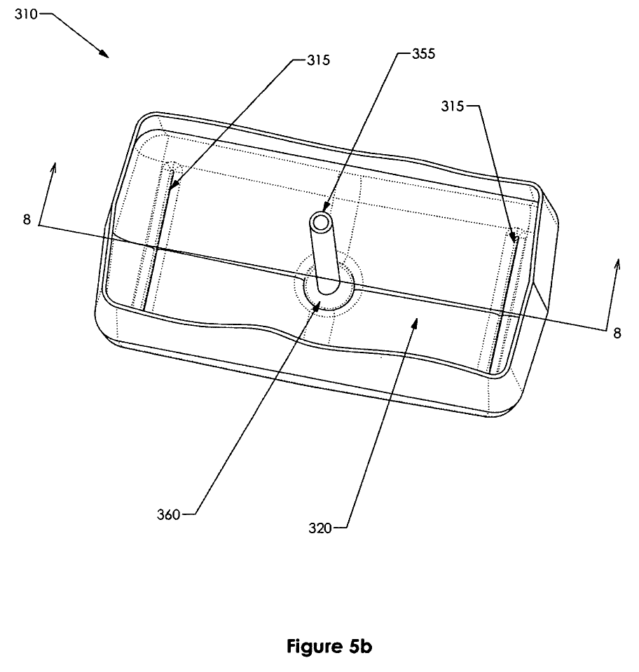

A bottom portion 310 of a third embodiment container is illustrated in FIGS. 5a-5b. It comprises a bottom wall 320 that gently slopes towards the wall's center wherein an indentation is provided to act as a liquid reservoir 360. The depth of the reservoir is typically sufficient when it is filled with liquid to facilitate the operation of the pump dispenser. In other words, if the reservoir is filled, the siphon tube 355 (if placed in the reservoir) is capable of drawing liquid through its intake. Accordingly, a user can draw almost all the liquid provided in the container through the pump dispenser save for only a very small volume of residual liquid in the indentation reservoir.

To facilitate stable placement of the third embodiment container on a flat horizontal surface, such as a shelf, a pair of widthwise extending legs 315 are provided on the longitudinal ends of the container's bottom portion. The height of the legs is sufficient such that the bottom exterior surface of the indentation (or reservoir) is raised at least slightly above any horizontal surface on which the container is placed. Alternatively, the bottoms of the legs and the bottom of the reservoir can be generally co-planar thereby providing three places of contact with a horizontal shelf surface.

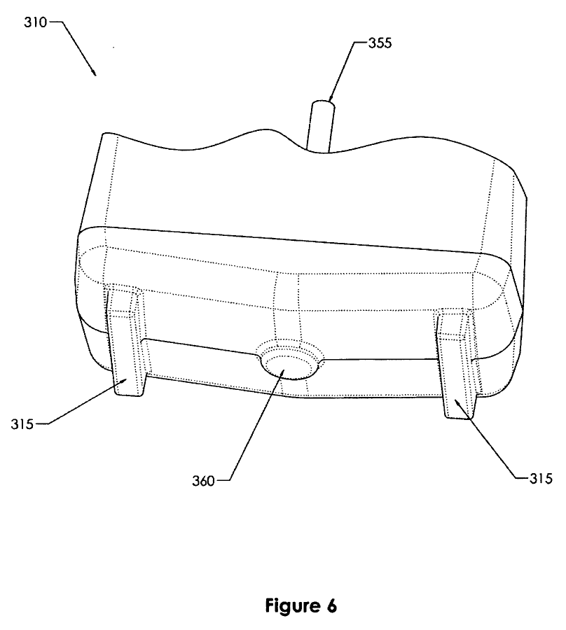

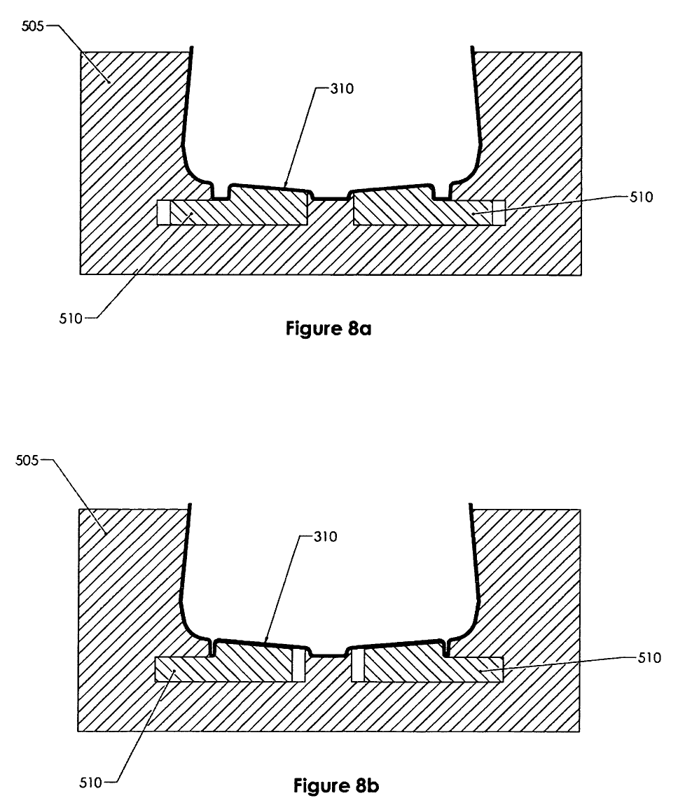

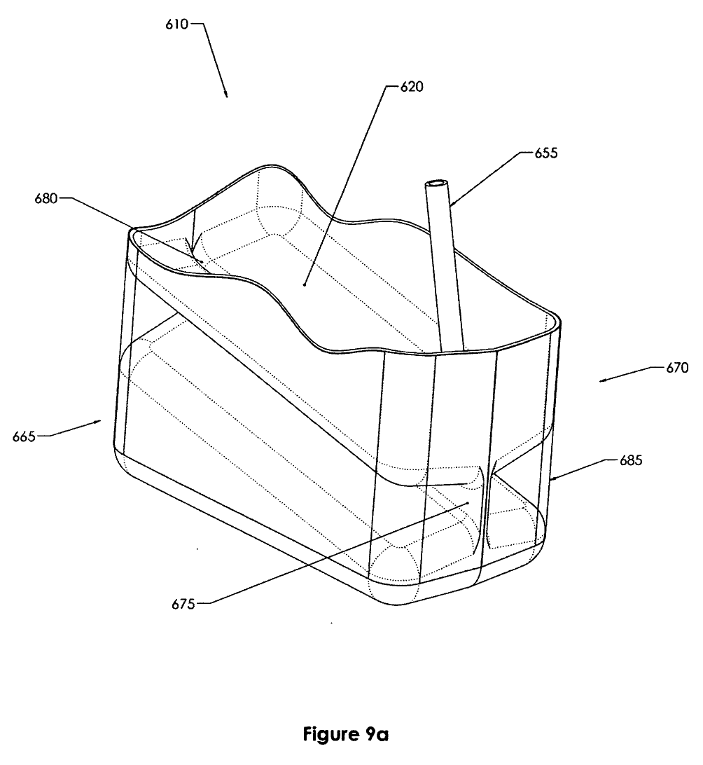

Referring to FIGS. 8a & 8b, the container of the third embodiment is preferably fabricated in a similar manner as the second embodiment. First, the container is blown from a blank or preform into a substantially complete configuration as shown in FIG. 6. Next, before the molten or semi-molten polymeric material has had the opportunity to solidify against the cooler surfaces of the mold's pieces 505, 510 & 515, a pair of sliders 510 move inwardly to compact the as-blown sides of the legs 315 (FIG. 6) together against the bottom mold piece 515. After compaction, the polymeric material solidifies and the mold pieces separate to release the container.

### A Fourth Embodiment Container

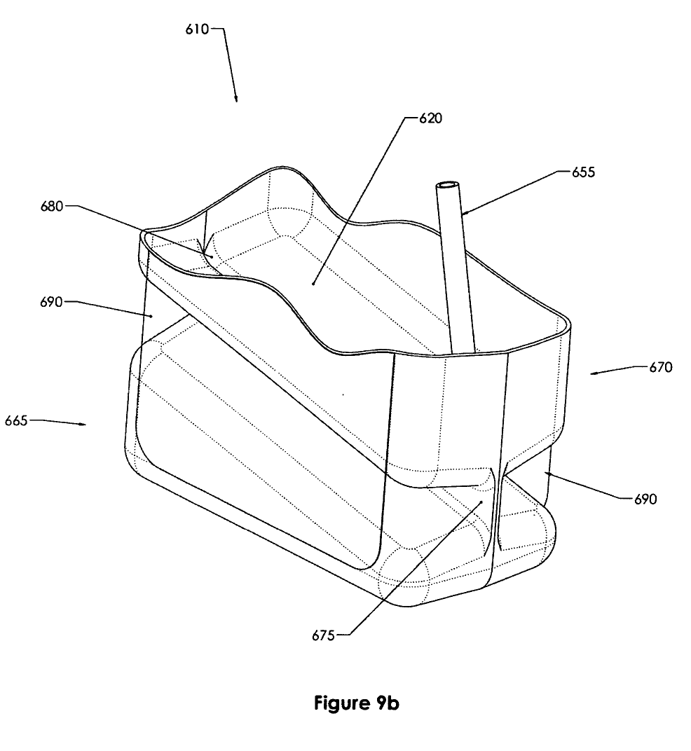

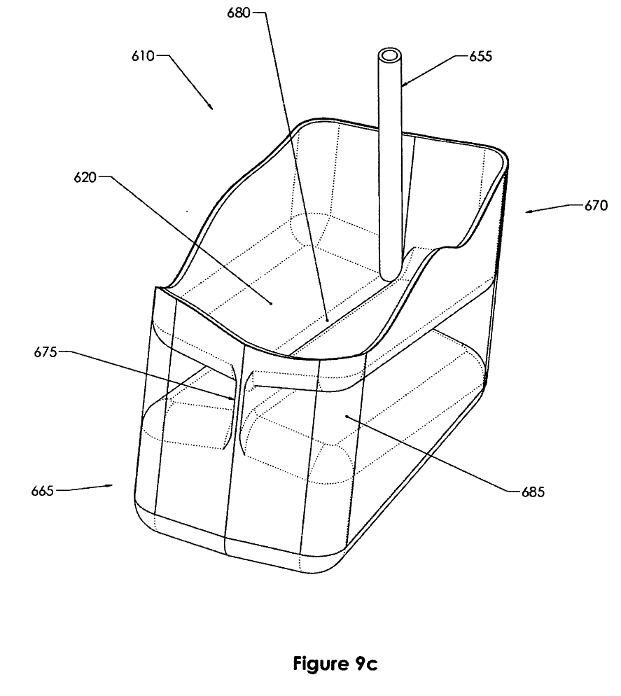

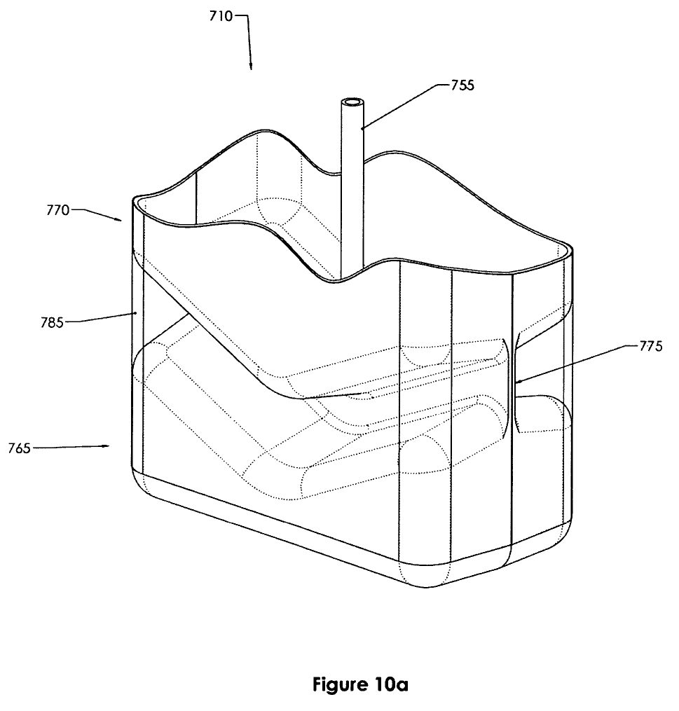

Bottom portions 610 of two variations of a fourth embodiment container are illustrated in FIGS. 9a-9c. The fourth embodiment comprises a substantially hollow bottom section 665 that is separated from a top section 670 by a tack-off feature 675.

The fluid associated with the container is typically contained within the top section and includes a bottom wall 620 that slopes downwardly from a high end to a low end. Also along the proximate longitudinal center of the bottom side, a trough 680 (or channel) also slopes from the high end to the low end of the bottom side. A siphon tube 655 is provided with its bottom end being located proximate and preferably in the trough at the low end of the bottom side. Accordingly, a user can efficiently draw nearly all the liquid from the top section of the container save for a very small amount located in the trough at the bottom side's low end.

The bottom section 665 is substantially hollow and typically fully enclosed. It is most importantly characterized by a substantially flat and horizontal bottom wall from an acute angle relative top the bottom wall 620 of the top section 670. The primary function of the bottom section is to provide a stable base to hold the container in an upright orientation.

The tack off section 675 is formed by compressing two opposing sides together just subsequent to blowing of the blank against the exterior walls of an associated tool and prior to the molten polymer fully solidifying. To compress the opposing sides of the container together, appropriately configured slides (not shown) are provided in the mold that operate in a generally similar manner to the slides described above in relation to the second and third embodiments. During the blowing phase of fabrication, the opposing sides of the slides are flush with the associated side surfaces of the mold. Once the container is blown the slides are pushed by way of pneumatic, hydraulic or mechanical means towards each other to not only form the tack-off feature but also the bottom wall 620 of the top section 670 and it associated trough 680. Once the polymeric material has fully solidified, the slides are retracted, the mold is opened and the container is removed.

The stability of the top section 670 relative to the bottom section 665 in part depends on the thickness and associated strength and rigidity of the tack-off feature 675. For instance, if the tack off feature is too flexible, the top section may pivot relative to the bottom section along the tack-off feature. To prevent this issue, a tack-off feature of sufficient thickness is provided in some variations. To further stabilize the container proximate the tack-off feature, one or more thin flexible substrate labels 685 or 690 maybe adhesively adhered to the surfaces of the top and bottom sections. In FIG. 9a, a single label 685 circumscribes the container and spans the distance between the top and bottom sections. In FIG. 9b, two separate labels are provided on opposite longitudinal sides of the container and span between the top and bottom sections. The labels are typically comprised of a thin sheet of polymeric material, although the labels maybe comprised of other suitable materials as well including but not limited to pulp-based papers. The labels typically will have product indicia and other printed materials thereon.

Functionally, the labels act as tension members to effectively prevent the top section from pivoting relative to the bottom section along the tack-off feature. When the load or weight of the top section shifts leftwardly, the right label 690 or right portion of a single label 685 is tensioned to prevent any significant or substantial pivotal movement of the top section. Conversely, when the load or weight of the top section shifts rightwardly, the left label 690 or left portion of a single label 685 is tensioned to prevent any significant or substantial pivotal movement of the top section.

### A Fifth Embodiment Container

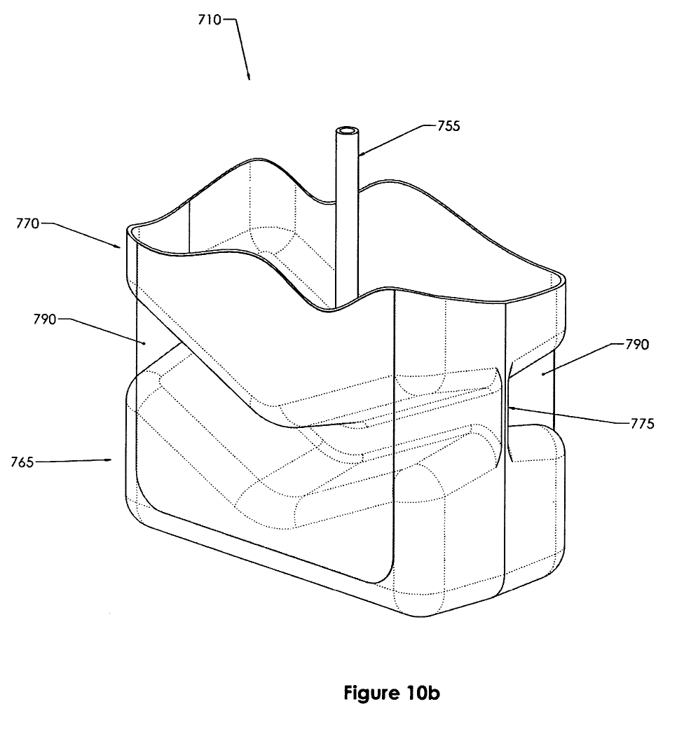

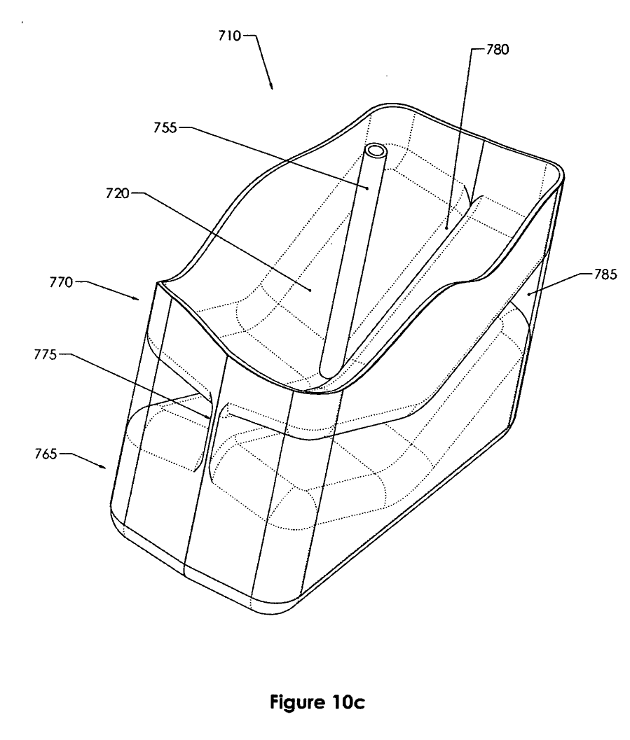

Bottom portions 710 of two variations of a fifth embodiment container are illustrated in FIGS. 10a-10c. The fifth embodiment, similarly to the fourth embodiment, comprises a substantially hollow bottom section 765 that is separated from a top section 770 by a tack-off feature 775.

Except for obvious visual differences, the tack-off feature 775 and the bottom section 765 of the fifth embodiment are generally similar to the corresponding features in the fourth embodiment. The manner of manufacturing the fifth embodiment container is substantially the same as the fourth embodiment. Furthermore, variations of the fifth embodiment include single label 785 and multiple label 790 variations that are substantially similar to the labels of the fourth embodiment in both configuration and operation.

The primary difference between the fifth and fourth embodiments is that the bottom wall 720 is sloped inwardly from the two lateral sides of the container to a low point at the proximate middle of the container. Similarly, the trough 680 (or channel) slopes towards the proximate center. A siphon tube 755 is typically provided that terminates at an end proximate the intersection of the downwardly sloping troughs near the low point of the bottom wall 720.

Given the design of the fourth and fifth embodiments in general and the tack-off feature specifically, alternative embodiments and variations are contemplated having differing shapes and container configurations as would be obvious to one of ordinary skill in the art given the benefit of this disclosure.

### Alternative Embodiments and Variations

The various embodiments and variations thereof illustrated in the accompanying Figures and/or described above are merely exemplary and are not meant to limit the scope of the invention. It is to be appreciated that numerous variations of the invention have been contemplated as would be obvious to one of ordinary skill in the art with the benefit of this disclosure.

For instance, the size and shape of the various containers can vary substantially. The containers need not be rectangular in shape. Rather, they can be cylindrical, ovalized or any other suitable shape. Further, the placement, shape and number of legs can vary substantially as well. For example, a cylindrical bottle could be produced that has one or more compacted legs situated around the periphery of the bottle's bottom side. Likewise, the location and configuration of the liquid reservoir in which the bottom inlet end of the siphon tube is received can also embody any number of suitable configurations other than the trough and the circular indentation illustrated in the above embodiments.

Simply stated, embodiments of the present invention in the broadest sense comprises any unitary plastic container for use with a blow molded pump dispenser that includes (i) integrally molded legs permitting the container to be stable when placed uprightly on a horizontal surface, and (ii) a reservoir area located in the interior bottom of the container into which the contents of the container drain. In certain embodiments, one or more legs of a container are compacted or compressed such that they include little or no interior volume in which liquid can congregate.

Embodiments of the present invention also include the methodology of making a container satisfying the above criteria. In the case of injection blow molding, first, a suitable blank or preform is placed in a mold. The preform, which is heated until its polymeric material is at least partially molten, is blown to form the container. In certain variations, one or more slide pieces of the mold are actuated to compress as-blown legs before the material in the legs solidify. Although typically not required, in some variations the slide pieces can be separately heated relative to the remainder of the mold to maintain the pieces at an elevated temperature relative to the other mold surfaces. Accordingly, the polymeric material in contact with the slide pieces will not solidify as quickly as material in contact with other mold surfaces thereby facilitating the compaction process and the fusing of adjacent sidewalls. Finally, the container is removed from the mold. The entire process can be and typically is highly automated.

We claim:

1. A polymeric container comprising:
a bottom side, the bottom side having an interior and exterior surfaces;
first and second legs extending from the bottom side, each leg including a bottom end, the bottom ends of the first and second legs defining a substantially hypothetical horizontal plane;
one or more substantially vertical sides extending upwardly from the bottom side; and
a substantial majority of both the interior and exterior surfaces of the bottom side comprising a substantially planer wall, the substantially planar wall forming an acute angle with the horizontal plane;

2. The container of claim 1 formed using a blow molding process.

3. The container of claim 1, further including a third leg, the third leg having a bottom end substantially located in the horizontal plane and forming a trough on the interior surface of the bottom side, an edge of the trough intersecting with a first end of the planar wall, the first end of the planar wall being the end of the planar wall located vertically the closest to the horizontal plane.

4. The container of claim 3, further comprising a pump dispenser and a siphon tube, the siphon tube extending from the pump dispenser at a first end to second end located within the trough.

5. The container of claim 1, wherein the bottom side is substantially rectangular and the one or more substantially vertical sides comprise first and second longitudinal sides and first and second lateral sides, the substantially planar wall sloping downwardly at the acute angle from proximate the first lateral side to proximate the second lateral side.

6. The container of claim 5, wherein the first leg extends longitudinally linearly proximate the first longitudinal side and the second leg extends longitudinally linearly proximate the second longitudinal side, and further comprising a third laterally extending leg located proximate the second lateral side, the third leg forming a trough on the interior surface of the bottom side.

7. The container of claim 5, wherein the first and second longitudinal legs form respective interior longitudinal troughs.

8. The container of claim 1, wherein the first and second legs substantially do not form interior longitudinal troughs and the thickness of the first and second legs are each generally twice the thickness of the one or more substantially vertical sides.

9. The container of claim 1, formed by (i) heating a blank comprised of a polymer to a molten or semi-molten state, (ii) blow molding the container against associated mold surfaces, and (ii) subsequently compacting the first and second legs to substantially eliminate associated first and second leg interior troughs formed during said blow molding prior to both complete solidification of the polymer and removal of the container from the mold.

10. The container of claim 8, wherein the bottom side is substantially rectangular and the one or more substantially vertical sides comprise first and second longitudinal sides and first and second lateral sides, the substantially planar wall sloping downwardly at the acute angle from proximate the first lateral side to proximate the second lateral side.

11. The container of claim 10, wherein the first leg extends longitudinally linearly proximate the first longitudinal side and the second leg extends longitudinally linearly proximate the second longitudinal side, and further comprising a third laterally extending leg located proximate the second lateral side, the third leg forming a trough on the interior surface of the bottom side.

12. A method of manufacture of a polymeric container, the method comprising:
heating a blank until the associated polymer is molten or semi-molten
placing a blank into a blow molding mold;
blowing a pressurized gas into the blank forming an intermediate container with substantially all its walls in direct contact with associated mold surfaces,
the intermediate container comprising,
a bottom side, the bottom side having an interior and exterior surfaces,
first and second legs extending from the bottom side, each leg including a bottom side, the bottom sides of the first and second legs defining a hypothetical substantially horizontal plane, each leg further having left and right sidewalls spaced from each other and intersecting with the bottom side, and
one or more substantially vertical sides extending upwardly from the bottom side;
compacting one or both of the left and right sidewalls against the other eliminating spacing therebetween;
permitting the polymeric material to solidify; and
removing the container form the mold.

13. The method of claim 12, wherein said compacting further comprises, sliding movable pieces of the mold in contact with one or both of the left and right sidewalls of the first and second legs relative to other pieces of the mold.

14. The method of claim 13, wherein the movable pieces are hydraulically, mechanically or pneumatically operated.

15. The method of claim 12, wherein said blowing and said compacting are performed sequentially without an intermediate heating operation.

16. The method of claim 12, wherein said blowing, said compacting and said permitting all occur sequentially as presented after said placing and before said removing.

17. A container manufactured by the process of claim 12.

18. A blow molded polymeric container comprising:
a bottom side having a wall of generally uniform thickness, one or more first portions of the wall being sloped acutely downwardly relative to horizontal towards a reservoir formed on an interior surface of the bottom side by one or more second portions of the wall, a bottom interior surface of the reservoir being vertically below the interior surfaces of the one or more first portions; and
at least first and second legs extending downwardly from the bottom side, the bottom ends of the legs being substantially planar with each other and defining a hypothetical horizontal plane, each leg being unitarily formed with said bottom side and comprising a single wall.

19. The blow molded polymeric container of claim 18, wherein the reservoir comprises a trough.

20. The blow molded polymeric container of claim 18, wherein the reservoir is located proximate a center of the bottom side.
